(19) United States
(12) Patent Application Publication
(10) Pub. No.: US 2016/0020854 A1
(43) Pub. Date: Jan. 21, 2016

(54) System to enable communication, sometimes called Li-Fi or Visible Light Communication ( V.L.C. ) between computers or broadcast programs and simple microcontroller gadgets with limited user interfaces, to further the "internet of things"

(71) Applicant: Allen Howard Engel, Auburn, WA (US)

(72) Inventor: Allen Howard Engel, Auburn, WA (US)

(21) Appl. No.: 14/332,325

(22) Filed: Jul. 15, 2014

(51) Int. Cl. H04B 10/116

(52) U.S. Cl. CPC H04B 10/116

(57) ABSTRACT

A simple system to enable communication between computers, or mobile computers, or computer driven television displays, or broadcast programs and microcontroller gadgets with limited user interfaces.

### BACKGROUND

1. Prior Art

The following is a tabulation of some prior art that presently appears relevant:

### U.S. Patents

| Pat. No. | Date Issued | Patentee |
|---|---|---|
| 5,136,644 | 1992 Aug. 14 | Audebert, et al. |
| 5,488,571 | 1996 Jan. 30 | Jacobs, et al. |
| 5,742,260 | 1988 Apr. 21 | Fishman, et al. |
| 6,977,868 | 2005 Dec. 20 | Brewer, et al. |
| 20090232515 | 2009 Sep. 17 | Marien, Dirk |
| 20140082076 | 2014 Mar. 20 | Hoptroff, Richard |
| | | George |

### Foreign Patent Documents

| Foreign Doc. Nr. | Cntry Code | Pub. Dt | App or Patentee |
|---|---|---|---|
| EP1211841B1 | GB | Jan. 11, 2006 | La Puente Arrate, et |
| | | | al |
| EP1788509A1 | DE | May 23, 2007 | Muller, et al. |
| GB2376115A1 | GB | May 29, 2001 | Hoptroff, Sarl |
| WO2011007380A1 | IT | Jan. 20, 2011 | Agostino, Roberto |

### REFERENCES

http://www.hardingfpa.com/assets/Downloads/HardingFPA-X-Users-Manual.pdf
Ashton, Kevin (22 Jun. 2009). “That ‘Internet of Things’ Thing, in the real world things matter more than ideas”, R.F.I.D. Journal
Manual Optimus comfort 1v01 Tan Optimus Comfort Manual, Kobil, Germany.
Low-Complexity Visible Light Networking with l.e.d.-to-l.e.d. Communication, Domenico Giustiniano, Nils Ole Tippenhauer, Stefan Mangold, Disney Research, Zurich, Switzerland, Wireless Days (WD), 2012 IFIP, 21-23 Nov. 2012.
Toys communicating with LEDs: Enabling Toy Cars Interaction, Nils Ole Tippenhauer, Domenico Giustiniano, Stefan Mangold, Disney Research.
Very Low-Cost Sensing and CommunicationUsing Bidirectional l.e.d.s, Paul Dietz, William Yerazunis, Darren Leigh TR2003-35 July 2003, UbiComp 2003: Ubiquitous Computing, Lecture Notes in Computer Science, Volume 2864, 2003, pp 175-191.
http://visiblelightcomm.com/top-10-li-fi-myths/ Gordon Povey
http://www.hardingfpa.com/about-us-resources/broadcast-guidelines/

### BACKGROUND

Modern cell phones and tablets have significant computing power. Modern cell phones and tablets are very intelligent devices. Likewise notepads, laptops, personal organizers, notepads, laptops, personal organizers, Android cellular telephones, Apple iOS phones and tablets, JavaME enabled feature phones, a Windows phone or Windows tablet, computer driven television displays, along with Blackberrys, Palms, etc. are examples of intelligent computers and mobile computers.

Kevin Ashton predicts “internet of things”, that many low cost devices will be connected to the internet. If the “internet of things” (herein referred to in this patent as “iot”) device has a microcontroller and sensors for electromagnet radiation, the device can achieve a continuous or intermittent connection to the internet.

The computing power of intelligent devices like modern cell phones and tablets is used to perform many of the tasks formerly performed by application specific devices. For example, consumers are very accustomed to using the keyboard on their intelligent devices. Therefore, their intelligent device can perform the keyboard functions for a low cost “internet of things” device, transmitting the intelligent device users keystrokes to the iot device or gadget.

Likewise intelligent cell phones and devices can take over many of the computing tasks for the low cost iot device. For example, the consumer could use a fun app on their intelligent cellular phone to custom design pixel icons that are transmitted to the display of a low cost iot gadget.

Moreover intelligent cell phones and devices can interactively guide the consumer in customizing, programing, and operating a low cost iot device. The consumer's intelligent device can guide and prompt the consumer to maximize their enjoyment of their low cost iot device. The intelligent device can transmit data at very low cost to the iot device with “visual light communication”, comprised of flashes of electromagnetic radiation.

For the purposes of this patent a flash is described as a rapid transition from a low value of electromagnetic radiation to a higher value of electromagnetic radiation. Similarly a flash is also a rapid transition from a high value of electromagnetic radiation to a lower value of electromagnetic radiation. Based on the recommendations of the World Wide Web Consortium (W3C) regarding not exceeding 3 flashes per second, each flash would have a duration of approximately 333 milliseconds or less. And since each flash is actually comprised of a low value frame transitioning to a high value frame, and vice versa, each frame would have a duration of approximately 166 milliseconds or less.

Visual light communication aka V.L.C. or Li-Fi uses light flashes and pulses to transmit data. For example, the light flashes from an l.c.d. screen can transmit the transitions from CLOCK low to CLOCK high, and vice versa. The l.c.d. screen can also transmit the transitions from DATA low to DATA high, and vice versa. For example, CLOCK low can be a low luminosity hue, whereas CLOCK high can be the same hue at a higher luminosity. Same for DATA low and DATA high. Nowadays most intelligent devices have an l.c.d. screen, or l.e.d. screen, or el screen, and other screens. Worldwide there are billions of intelligent cellular phones and tablets with display screens. These intelligent devices can transmit data with light flashes from their displays, requiring few or no additional hardware components to do so, at little or no cost. V.L.C. is virtually the only communications method that can be performed by virtually every device with a display on the planet.

Gordon Povey, Honorary Fellow at University of Edinburgh teaches: “V.L.C. Is a simple technology since it uses direct modulation and direct demodulation. Infra-red remote controls are very low-cost for exactly the same reason. On the other hand radio technology is complex since it requires radio frequency circuits to modulate the data onto the radio bearer and then it requires an antenna system to transmit the signal. The radio receiver is often more complex requiring an antenna system, radio receiver and carrier synchronization circuits. Therefore V.L.C. Is much simpler than the equivalent radio system.”

As the “the internet of things” becomes ubiquitous, the available radio frequency spectrum is becoming filled with radiation from many different devices. There is less and less bandwidth available for an increasing number of new devices.

Visual light communication is secure and robust. Light does not penetrate through walls, whereas Bluetooth does readily. Dietz et al. Of Mitsubishi Research Labs teach: “With visible light you can shine a beam of light in a very controlled way. Not only that, you can see exactly where it goes. V.L.C. therefore has inherent security so there is no need to confirm or accept the device pairing.” V.L.C. is already widely used in Germany for banking

In addition they teach “V.L.C. is inherentaly safer for children versus the interior of a car which is a vitual Faraday cage.”

There are many problems with prior art that do not satisfy the need for communication between laptops, notebooks, organizers, tablets and cellular phones with low cost iot devices.

Near Field Communications (N.F.C.) and Radio Frequency Identification (R.F.I.D.) functions well for data transmission. However, in 2014 N.F.C. is only available in a limited number of Android devices, and is not yet available for iOS devices.

Methods are also known that allow an electronic device to be connected to a USB port or the like, through a cable. However, in addition to the connecting cable, the hardware interfaces have high costs which make the device itself less competitive on the market. Indeed, an onboard interface of the device itself is essential to connect such a device to a USB port or the like, an interface that consists of electronic chips that increase significantly the manufacturing cost.

Currently Bluetooth semiconductors cost about $1.00 each in bulk quantities, whereas a commodity 8051 microcontroller costs about $0.08 each in bulk quantities. In addition, the receiving device needs a Bluetooth antenna, and Bluetooth software. The Bluetooth software requires many kilobytes of memory. Most commodity microcontrollers have limited amounts of memory, so expensive memory chips are also required for the Bluetooth software.

Q.R. Codes have not been widely adopted by consumers. And the software and microprocessor power to process Q.R. Codes is not commonly possessed by low cost microcontrollers.

Casio Picasicamera requires two intelligent devices to communicate. And the flashing colors of the Casio Picasicamera are disturbing, disorderly, and confusing. Especially the flashing red colors.

An early Datalink system from Timex and Microsoft requires a CRT for clock. Another old version of Datalink for later Windows versions requires a relatively expensive light flasher.

Optisec from Kobil of Germany, aka Chiptan Flickerer, is mentally disturbing, disorderly, inherently confusing to use, and is likely to cause a few blank stares. The high contrast black and white stripes are discouraged by the W3C commission, as is its flashing, which exceeds 4 flashes per second. The flashing of the Chiptan Flickerer repeats continuously, and can be mesmerizing and hypnotic for some vulnerable people. Young girls and boys and pre-teens are especially susceptible to harm from flashing, but they are ironically drawn to the same flashing that harms them.

The Kobil Optisec system has 4 DATA emitters and 4 DATA receivers. The Flickerer system consists of bright white stripes, followed by contrasting black color stripes, that is, no light. This system does not incorporate modern multiple color light detectors. For example, low cost multiple color light detectors are able to distinguish between blue and blue green, green and green red, and red.

Some of the difficulties in using the Chiptan Flickerer are indicated by this quote from Kobil's Tan Optimus Comfort Manual: “Position the up-facing arrow tips on the device flush against the down-facing arrow tips on the screen. You may possibly have to change the size of the blinking field using the “+” and “−” buttons until the tips of the arrow markings point at each other. The device screen will now show the message “Searching start” or “Transmission”. Keep holding the device up to the computer screen as motionless as possible . . . .”

The manual encourages the user to hold the receiving unit motionless. The Optisec/Chiptan Flickerer system requires orientation of the receiving unit relative to the sending unit. Orientation is necessary to align the clock receiver with the clock emitter, and to align all 4 discrete data receivers and emitters. Imagine the difficulty of using the Chiptan Flickerer at an outdoor ATM in Hamburg during a winter windstorm.

In EP17885004 May 23, 2007 Mueller, et al. in their advertising literature illustrate a keyboard of high contrast black and white stripes that flash at a rate over 3 flashes per second.

Similarly U.S. Pat. No. 5,136,644, Aug. 14, 1992 Audebert specifies “phototransistors being in particular arranged in a straight line. And “phototransistors, are provided with buffers especially of an elastomer material, permitting better contact with a terminal screen”. U.S. Pat. No. 5,136,644 requires the 3 phototransistors arranged in a straight line, otherwise the optical signals overlap and are not parsable. Imagine the difficulty of using this Telecash device on a January day in Bad Vilbel (Frankfurt), with an average January air temperature of 27 degrees F.

In EP1211841B1, Jan. 11, 2006 La Puente Arrate, et al. describe an external signing device for a p.c., which also has disturbing flashing black and white stripes.

In GB2376115A1, May 29, 2001, Hoptroff, Sarl teaches a flasher that flashes at speeds greater than 3 flashes per second. And the flashing is mentally disturbing, disorderly, confusing to use, and likely causes a few of blank stares. And like the Chiptan Flickerer, the user must align the clock emitter to the clock receiver, and likewise the data emitter to the data receiver.

In WO2011007380A1, Jan. 20, 2011, Roberto Agostini teaches a “flash sequence in the form of light, with the strong difference in contrast (white→black Bit=0→Bit=1) reaches the portable electronic device.”

Dr. Graham Harding, Honorary Member of the Royal College of Physicians, U.K., teaches about browser content “A potential harmful luminance flash is where: The opposing changes in luminance have at least 20 cd/m2 contrast, AND the darker image is below 160 cd/m2, AND there are more than 3 flashes per second, AND those flashes occupy more than 25% of the video screen.”
http://www.hardingfpa.com/about-us-resources/broadcast-guidelines/

Similarly the World Wide Web Consortium (W3C) teaches a “general flash threshold”, with a size restriction “less than” 25% of any 10 degree visual field, and any single flashing event on a screen (there is no other flashing on screen) that s smaller than a contiguous area of 21,824 sq pixels (any shape), would pass the General and Red Flash Thresholds.”

Broadcasters, cartoon artists, web designers and game designers are aware of the warnings about harm from flashes taught by Dr. Harding and the W3C. For several years now flashes have been mostly absent from broadcast entertainment, programs, movies, cartoons, websites, and video games.

### Advantages

Accordingly several advantages of one or more aspects are as follows: It would be an advance in the art if intelligent devices would communicate to microcontroller controlled iot devices, would not need a physical connection between the intelligent device and the low cost iot device, would be low cost, would incorporate infrared or ultrasound emissions that the consumer does not sense, would not emit disturbing and confusing fast flashing emissions of contrasting hues, (especially not flashing saturated red color flashes, or black color flashes, or white light flashes, or short duration high contrast combinations of black frames followed quickly by white light frames, or black frames and red light frames, and white frames and red light frames), would not emit flashing bright intensity light followed by low ntensity light and vice versa, would not require line of sight alignment of the intelligent device with the low cost iot device, would enable viewer activities during entertainment broadcasts like cartoons, television episodes, and commercials, and could be incorporated into broadcast entertainment programming without harming consumers.

Other advantages of one or more aspects will be apparent from a consideration of the drawings and ensuing description.

### DRAWINGS—FIGURES

The drawings and examples below summarize some of the embodiments of this patent. Many other variants of the embodiments beyond the scope of this table can be practiced by one skilled in the art. This table does not define or limit the myriad possible applications of this patent.

FIG. 1 shows an overall view of the intelligent device and the iot device of the first embodiment.

FIG. 2 shows some of the common modules comprising the semiconductors of the iot device.

FIG. 3 shows a flowchart of the user interface

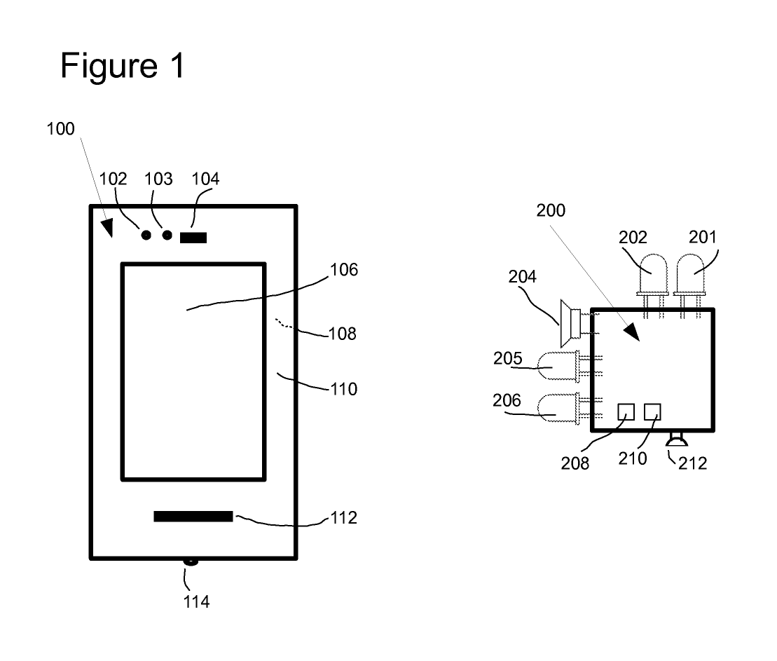

### FIG. 1—DETAILED

The intelligent device 100 is chosen from the group of cellular phones, tablets, notebooks, laptops,and the like. Gadget or iot device 200. Intelligent device 100 has a proximity sensor 102, which is usually an infrared emitter and receiver. Some of the intelligent devices for sale today have an “Infrared Blaster” 103, which can perform most of the functions of a modern infrared remote controller. In some embodiments the iot device 200 has two infrared receivers 201 and 202. In some embodiments the infrared receivers 201 and 202 also function as infrared senders. Intelligent device 100 has a sound emitter 104. Sound emitter 104 can emit sound which can be received by a microphone or piezoelectric transducer 204 of iot device 200. Intelligent device 100 has a display 106, which is selected from the group comprising l.e.d. displays, e.l. displays, l.c.d. displays, electrophoretic displays, quantum dot displays, p.d.l.c. displays, cholesteric displays, and guest-host displays. In some embodiments iot device 200 has visible light photocells or phototransistors or visible light emitting (and receiving) diodes 205 and 206. In some intelligent devices 100 have an N.F.C. chip 108. N.F.C. chip 108 can communicate asynchronously or synchronously with N.F.C. or NW module or chip 208 on iot gadget 200. Some intelligent devices 100 have a Bluetooth semiconductor 110. Likewise in some embodiments of iot device 200 there is a Bluetooth semiconductor 210. And in other embodiments iot device 200 has a sound generating buzzer or sound generating chip 212, while intelligent device 100 has a microphone 112. In some embodiments, the intelligent device 100 has a flashlight component, a high intensity white light l.e.d. 112.

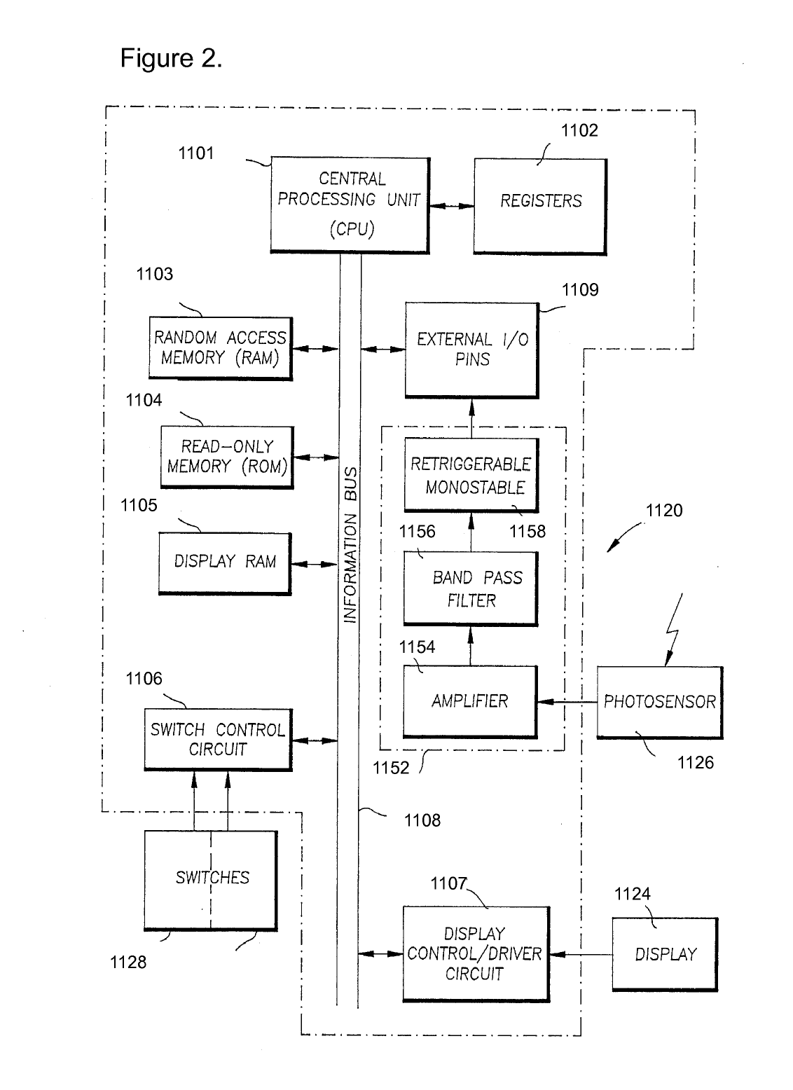

### FIG. 2—DETAILED

FIG. 2 shows the internal configuration of portable device 1120. Control of device 1120 is accomplished by central processing unit (CPU) 1101, which is directly connected to registers 1102. CPU 1101 utilizes registers 1102 to temporarily store data during information processing. CPU 1101 is coupled to the remaining internal hardware via information bus 1108. CPU 1101 accesses random access memory (RAM) 1103 via bus 1108 for data storage and retrieval during various operations. Read-only memory (ROM) 1104 is used to store the initial power-up programs for CPU 1101, as well as other information, a suitable operating program for controlling alternate functions, and is also coupled to CPU 1101 via bus 1108.

Display RAM 1105 is also connected to bus 1108, and is used by CPU 1101 and display control/driver circuit 1107 to control the iot display 1124. Display circuit 1107 is connected between bus 1108 and display 1124. Photosensor 1126 is coupled to CPU 1101 through interface circuit 1152 to external I/O pins 1109, which are connected to bus 1108. Switches 1128 and 1130 are connected to switch control circuit 1106, which is connected to bus 1108. CPU 1101 controls the operation of device 1120 based upon inputs from the switches and photosensors, as well as current system status.

The aforementioned elements 1101 through 1109 are preferably incorporated as a single integrated circuit contained within the casing 1132 of the portable information device 1120. For example, such a microprocessor-based integrated circuit was available from Motorola Corporation as model MC68HC05HG, including a timer, real time clock system, asynchronous serial interface, synchronous serial interface, LCD drivers, keyboard, switch and electroluminescent lamp outputs, with ROM and RAM memory adapted to store data as described in this application.

The light flashes seen by photosensor 1126 contain data information but they are unsuitable for receipt by external I/O pins 1109. Transformation of the data to a suitable serial format, as well as removal of extraneous light sources in accordance with some embodiments, is carried out by interface circuit 1152. Interface circuit 1152 may be a separate integrated circuit disposed inside casing 1212.

The novel portion of the software process becomes invoked only after the intelligent device software or the human user determines that Bluetooth is lacking in the system, or Near Field Communication is lacking in the system, or the IR Blaster 102 is lacking, or some other higher priority process is lacking in the system.

The novel portion of the software then either automatically chooses a novel method to transmit data between intelligent device 100 and iot device 200, or allows the human user the opportunity to activate the novel data transmission.

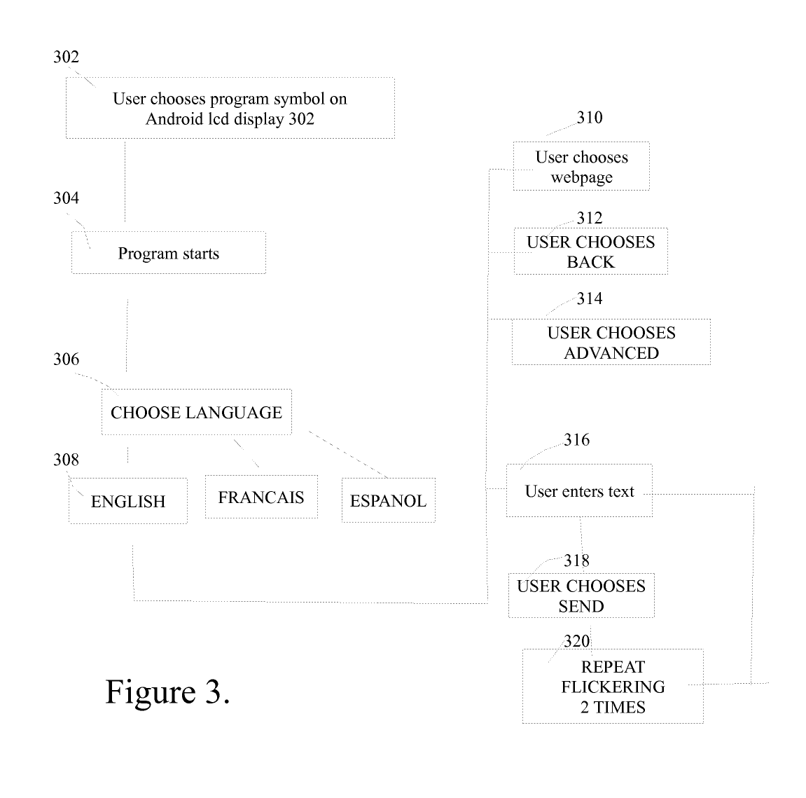

### FIG. 3—DETAILED

FIG. 3 is a flowchart one embodiment of the user interface. First the user is prompted to choose their language. Next the intelligent device displays a variety of choices including entering text, exiting the program, browsing to another website, amongst other choices. If the user chooses to enter text and then pushes the SEND icon, the translation of the user entered text commences and appears as a series of flashes on the users intelligent device display. After the flashing completes, the original text entry screen displays again on the users intelligent device display.

In some novel embodiments the infrared sender within the proxity sensor of the intelligent device emits a series of high speed infrared flashes corresponding to the transition from clock low to clock high, and vice versa. Since infrared flashes are not sensed by humans, the flash rate can be very rapid. The infrared flashes from the proximity sensor 102 can be sensed by infrared receiver 201 on iot device 200. In some embodiments the transmission can be synchronous, as the iot device 200 has an infrared receiver or combination infrared receiver/sender 201, 202.

There isprovided a system comprising a computer, or mobile computing device, or computer driven television display, or a broadcast program with a process to convert a digital transmission into flashes of electromagnetic radiation without causing harm to the human user of the system; and a gadget with a means to sense variations in the intensity and frequency and periodicity of flashes of electromagnetic radiation, and a process to convert the variations in the intensity and frequency and periodicity of the flashes of electromagnetic radiation into alphanumeric code.

The intelligent device is selected from the group comprising mobile phones, tablets, notebooks, laptops, electronic organizers and more. Most of these mobile computers are more capable than desktop computers were a decade ago. These devices can process data internally and transmit the data to other devices via a wide variety of means: cellular telephone modem, wi-fi, Bluetooth, N.F.C., R.F.I.D. and more important to this patent, via the light from the device display, or via the infrared emitter of the device proximity sensor, or via sound and ultrasound, or via a dedicated infrared transmitter such as the IR Blaster, or via the visible light l.e.d. flashlight.

Some of the embodiments convert patterns of wavebands of electromagnetic radiation emitted by a source such as a computer screen into a digital signal including a sequence of coded data symbols. These embodiments are based on the insight that the intensity of light, the frequency of light, and the periodicity of light can be easily sampled by a simple low-cost processor if appropriate A/D conversion hardware converts the incident light into an electrical signal which is time varying, whereby the base frequency of this electrical signal is a function of the characteristics of the flashes of electromagnetic radiation. The electromagnetic radiation used for channel coding and symbol clock can be recovered from the signal by the receiver.

The two devices transmit information on a peer-to-peer manner. The transmission is comprised of electromagnetic radiation flashes, as the difference in intensity, in frequency, and in periodicity (e.g. ruddy brown=Bit 0→medium brightness green=Bit 1) reaches the gadget. In many embodiments the transmission is asynchronous, with most of the computing being done by the intelligent device. In other embodiments the transmission is synchronous, if the iot gadget emit electromagnetic radiation back to the intelligent device.

Once the user has placed the iot microcontroller controlled device or gadget at close range to the intelligent device display, the light flashes emitted by the intelligent device are received by electromagnetic sensors that the iot device is provided with.

In some embodiments the data transmission is a serial-type transmission and the display can be seen as a transmitter that emits a sequence of electromagnetic radiation flashes, comprised of varying amounts of infrared flashes, or sound or ultrasound flashes, or blue pixels or subpixels emissions, or green pixels and subpixels, or red pixels and subpixels, modulated according to a specific communication protocol for the transfer of data needed for the iot device for its own configuration/programming/update, and each sensor on the iot device can be seen as a receiver that receives said flashes containing such data.

It is possible to improve performance by using a protocol with parity checks or more or less complex security controls known as checksum, that in the case of an error will discard the received data and signal the user to retry the ongoing update or setup, e.g. with light signals (Le.d. or other) emitted from the low cost iot device itself.

In some embodiments the surface of the entire computer display emits a single uniform visible light hue which the human user perceives a single color frame of short duration. In example 1, there are only 4 visible light hues, which represent the four possible states: ruddy brown for CLOCK low/DATA low, medium green for CLOCK high/DATA low, medium blue for CLOCK low/DATA high, and bright pastel blue green for CLOCK high/DATA high. The iot gadget, however, has one sensor which selectively absorbs one wavelength band from the intelligent device display emission for the CLOCK flashes, and another sensor which selectively absorbs a different wavelength band for the DATA flashes. In one embodiment of EXAMPLE 1, the gadget sensor for CLOCK is a sensor with a narrow absorption waveband peaking at 525 nm, which is approximately the peak emission of green for most r.g.b. displays. Likewise, in this same embodiment of EXAMPLE 1, the gadget sensor for DATA is a sensor with a narrow absorption waveband peaking at 455 nm, which is approximately the peak emission of blue for most r.g.b. displays.

Unlike prior art, in many novel embodiments the transmitting display is not divided into separate areas, with one area of the display emitting CLOCK flashes and another area emitting DATA flashes. Rather the emitting display is typically divided into pixels and subpixels of red, green, and blue. In some embodiments of EXAMPLE 1 most of the surface of the display emits CLOCK low and DATA low which are perceived by the user as a medium luminosity ruddy brown color, or CLOCK high and DATA low which are perceived as a little higher luminosity green color, or CLOCK low and DATA high as a similar luminosity blue color, and CLOCK high and DATA high as a even higher luminosity blue-green color.

Further, The ruddy brown color is comprised of about 20% green pixels, 20% blue pixels, and 60% red pixels, which is below the threshold of the gadget green photosensor, and below the threshold of the blue photosensor, indicating CLOCK low DATA low. The human eye perceives the overall luminosity of the ruddy brown color display as 50+50+100=200, as shown in Example 1.

For CLOCK high and DATA low the green color is below the threshold of the gadget blue sensor, but does trip the green sensor. The human eye perceives the overall luminosity of the display as medium green with a luminosity of about 255.

For CLOCK low and DATA high the blue color is below the threshold of the gadget green sensor, but does trip the blue sensor, indicating DATA high. The human eye perceives the overall luminosity of the display as medium blue with a luminosity of blue about 255, roughly the same luminosity as the CLOCK high and DATA low, as shown in Example 1.

The transparent blue-green display trips both the threshold of the gadget blue sensor and the gadget green sensor, indicating both CLOCK high and DATA high. The human eye perceives the overall luminosity of the display as green=200 and blue=200, for a total luminosity of 400, as shown in EXAMPLE 1.

Indeed, the display emits light relating to the transmission of DATA, by providing modulation of the (many fewer blue pixels→bright blue=255) light based on the bits to be transmitted (bit=0→bit=1), while simultaneously the display also emits light representing the transmission of CLOCK by providing modulaton of the (many fewer green pixels→bright green=255) light based on the bits to be transmitted (bit=0→bit=1) as a CLOCK signal synchronous to the data.

The gadget microprocessor and accompanying electronic components comprising the iot gadget assembly receives the visible light flashe from the gadget sensor, reads the pulse fronts of the CLOCK emissions, and at each front reads the state of the DATA line, thus rebuilding the sequence of the transmitted bits and therefore of the received data, performing conversion of analogue pulses to digital code.

In some embodiments, at the end of the proper transmission, the receiver can verify and then accept the data, if the number of received data bytes match the number of bytes to be transmitted declared in the beginning of the protocol, as transmitted by the intelligent device.

These intelligent devices have displays which emit blue light from about 425 nm to 480 nm, with a peak at about 455 nm. These devices emit green light from about 480 nm to 570 nm, with a peak wavelength at about 530 nm. And these devices emit red light from about 570 nm to 740 nm, with a peak wavelength at about 610 nm.

Narrow band wavelength emission and narrow band wavelength transmission filters enable the use of the transition from no or low luminance narrow band wavelengths of visible light hues to much higher luminance of the band, to signal the transition from CLOCK low to CLOCK high, and vice versa. Likewise narrow band filters with a variety of differeing sensitivities enable the transition from a different narrow band of visible light hues to transmit the transition from DATA low to DATA high, and vice versa.

Multiple visible light emission sources paired with matching absorption receptors would enable faster transmission rates. For example, 4 different reception optosensors could be used for DATA, sensing bits 0-3, but requiring only 1 CLOCK reception optosensor. Since the 4 reception optosensors sense different wavelengths, careful alignment of the optosensors to the emitting pixels is not necessary.

Careful selection of light absorbing dyestuffs or commercial filters will separate the visible light wavelenght bands for CLOCK transmission, from the wavelengths for DATA transmission. For example, in U.S. Pat. No. 4,808,501, Carl Chiulli of Polaroid cites the use of 5 chemicals, three of which are C.I. #12715, AKA Solvent Red 8; Solvent Yellow 88; and C.I. #61551, Solvent Blue 36. In U.S. Pat. No. 5,096,801 Koya et al., of Fuji Photo Film company, list some 150-200 chemical structures, mainly azo dyes and pyrazolone-diazenyl.

Exciton of Ohio USA distributes a variety of narrow band wavelength band absorbing dyestuffs. For example, a narrow band transmission dyestuff mixture could be comprised of a mixture of Exciton ABS dyes 473, 490, 511, & 527 nm dyes to absorb below light 540 nm, and also a mixture of Exciton ABS dyes 584, 594, 626 & 642 dyes, to absorb above 560 nm. This hypothetical Exciton mixture would transmit 540-560 nm wavelengths.

Giustiniano et al. teach that l.e.d.s can function as low cost light sensors when operated in a reverse bias mode. Therefore, l.e.d.s can function double duty for a low cost gadget: to emit light and to absorb light within a narrow wavelength band. These l.e.d.s do not need additional dye based filters to selectively absorb wavelengths in a narrow wavelength band.

To achieve a low cost gadget, the skilled worker could use a common low cost blue l.e.d. which has a peak emission (absorption) of 455 nm, and a common low cost green l.e.d. which has a peak emission (absorption) of 525 nm; and the two l.e.d.s approximately match the peak blue color emissions and peak green color emissions of many r.g.b. displays.

In some embodiments the intelligent device emits fewer than 4 “flashes” of light per second. Since there are fewer than 4 flashes of light per second, a large portion of the surface area of the intelligent device display can emit the light, or even the whole display can emit the light.

In some embodiments most of the surface area of the display emits the colors. However in other embodiments the emitting area of a 1024×768 visible light display can be reduced to about 85×85 pixels to comply with W3C guidelines.

In other embodiments, the communication can be synchronous between the iot device and the intelligent device. It is common for commodity microcontrollers to support an audio buzzer. After successfully receiving a transmission from the intelligent device, the iot device could emit an audio beep or buzz or success tone, which would be heard by the audio microphone of the intelligent device.

In some of these embodiments the visible light communication is emitted as infrared light flashes. Infrared light flashes are not disturbing to humans.

Most cellular phones and many tablets have a proximity sensor which emits infrared light. A mobile app would cause the infrared emitter to flash CLOCK flashes to the infrared receiver on the iot device. The infrared flashing cycle would coordinate with the visible light DATA flashing emitted by the display of the intelligent device.

To properly function as a proximity sensor for human users, the intelligent device proximity sensor usually appears on the same side of the intelligent device as the device display. When the consumer holds the intelligent device display a few inches from the iot device sensors, infrared flashes from the wide angle emitting infrared proximity sensor and visible light flashes from the display affects the sensors of the iot device. Little or no alignment of the senders and receivers is necessary. In fact the sending and receiving devices would not need to be in direct line of sight of each other. Sometimes reflected CLOCK pules and reflected DATA flashes are sufficient to transmit to the iot gadget.

Since low cost light emitting diodes can both receive and send light, synchronous communication between the intelligent device and the iot device is possible at low cost or no cost. In some embodiments the iot device can acknowledge receiving the DATA by emitting infrared light flashes back to the intelligent device, back to the infrared sender/receiver comprising the intelligent device proximity sensor.

Some intelligent devices such as the new Samsung Galaxy S4 have IR Blasters, the tradename for an infrared controller. Many of the embodiments in this patent for visual light communication techniques can be adapted instead to infrared light sending and receiving by someone skilled in the art.

In some novel embodiments the transitions from CLOCK low to CLOCK high and vice versa can be represented by rapid sound or ultrasound flashes from the sound generating component 104 of intelligent device 100. In some embodiments the sound is generated at frequencies higher than most humans can hear. The ultrasound “mosquito” ring tone that is enjoyed by naughty children whose parents and long suffering stepparents often cannot hear ring tones above 17 kHz. The sound flashes are received by the sound receiver 204 on iot device 200. In some embodiments the transmission can be synchronous, as the iot device 200 has a buzzer or sound generator 212 to communicate to the microphone 112 of intelligent device 100.

These same transitions can be performed with visible light emissions from the entire display 106, or portions of the display 106 of intelligent device 100. In the embodiments where the CLOCK is emitted by infrared, the DATA transition exhibited by the display 106 of intelligent device 100 can be very simple, comprised of a moderate luminosity hue for DATA low, and a higher luminosity hue for DATA high. The hue transitions can be sensed by the visible light sensor 205 of iot device 200.

In additional novel embodiments the CLOCK transitions from CLOCK low to CLOCK high and vice versa can be signaled by high frequency sound and ultrasound emissions from the sound generator 104 of intelligent device 100. Likewise In the embodiments where the CLOCK transition is emitted by sound or ultrasound, The DATA transitions exhibited by the display 106 of intelligent device 100 can be very simple, comprised of a moderate luminosity hue for DATA low, and another higher luminosity hue for DATA high. The hue transitions can be sensed by the visible light sensor 205 of iot device 200.

In still other novel embodiments, the novel software transmits solely from the visible light display 106 of intelligent device 100, to the visible light sensors 205 and 206 of iot device 200. In some novel embodiments there are as few as 4 different visible light hues emitted by display 106 of intelligent device 100, as shown by EXAMPLE 1.

In other novel embodiments the display of the computer or mobile computing device is comprised of different color emitting areas. One area of the display emits visible light comprising a plurality of wavebands, including a waveband flash to transmit a CLOCK transition to the gadget; and another separate area of the display which also emits visible light, visible light which also comprises a plurality of wavebands, including a waveband flash to transmit a DATA signal to the gadget, a waveband comprised of wavelengths different from the wavelengths of the CLOCK waveband.

EXAMPLE 1

| R | G | B | R | G | B |
|---|---|---|---|---|---|
| Clock High, Data High | | | Clock low, Data high | | |
| 0 | 180 | 180 | 120 | 60 | 160 |
| Clock high, Data low | | | Clock low, Data low | | |
| 120 | 160 | 60 | 100 | 60 | 60 |

EXAMPLE 2

| | | | | | | | | |
|---|---|---|---|---|---|---|---|---|
| R | G | B | R | G | B | R | G | B |

| Clock High, Data High | | | | | | Clock low, Data high | | |
|---|---|---|---|---|---|---|---|---|
| 0 | 180 | 180 | 60 | 120 | 170 | 120 | 60 | 160 |
| 60 | 170 | 120 | 50 | 120 | 120 | 110 | 60 | 110 |
| 120 | 160 | 60 | 110 | 110 | 60 | 100 | 60 | 60 |

| | |
|---|---|
| Clock high, Data low | Clock low, Data low |

EXAMPLE 3

| R | G | B | Tms | R | G | B | Tms | R | G | B | Tms | R | G | B | Tms |
|---|---|---|---|---|---|---|---|---|---|---|---|---|---|---|---|
| Clock High, Data High | | | | | | | | | | | | Clock low, Data high | | | |
| 0 | 180 | 180 | 32 | 40 | 140 | 170 | 8 | 80 | 100 | 165 | 8 | 120 | 60 | 160 | 32 |
| 40 | 170 | 140 | 8 | 45 | 140 | 140 | 8 | | | | | 110 | 60 | 130 | 8 |
| 80 | 165 | 100 | 8 | | | | | 75 | 100 | 100 | 8 | 105 | 60 | 90 | 8 |
| 120 | 160 | 60 | 32 | 110 | 130 | 60 | 8 | 105 | 100 | 60 | 8 | 100 | 60 | 60 | 32 |

| | |
|---|---|
| Clock high, Data low | Clock low, Data low |

R = Red
G = Green
B = Blue
T = Time in milliseconds

Example 1 shows that the luminosity between the various states remains relatively constant, around 255, even in the CLOCK low and DATA low states. In some prior art the luminosity emitted by the CLOCK senders and DATA senders transitioned from a low of 0 to 255, which is a strobe like light, which is disturbing to some people.

Many of the embodiments described in this patent comply with Dr. Graham Harding's F.P.A. test and the University of Wisconsin P.E.A.T. test.

One skilled in the art could use this patent's teachings and achieve higher frame periodicity rates, and still not fail Dr. Graham Harding's F.P.A. test or the University of Wisconsin P.E.A.T. test.

In some of these novel embodiments, the luminance or intensity from frame to frame does not vary sufficiently to exceed the Harding or Wisconsin test thresholds. For example, in some embodiments, the CLOCK low, DATA low frame is a total luminance of 280, comprised of Red 180, blue 50, & green 50. Whereas the CLOCK high, DATA high frame is comprised of Red 0, Blue 200, & Green 200, for a total luminance of 400. This difference in luminance between the frames of this example does not exceed the threshold of the tests.

One skilled in the art could also use shorter duration frames and still comply with the Harding or Wisconsin tests. For example, the color transition from the CLOCK low and DATA low frame could transition to the CLOCK high and DATA high frame with a series of inactive or non-representative frames that gradually change from one hue to the other.

EXAMPLE #2 has a transitional frame between the CLOCK low/DATA low frame preceding it and the CLOCK high/DATA high frame following it. This transitional frame has an intensity and frequency about halfway between the intensity and frequency of the two frames. The transitional frame is inactive and does not trip the gadget sensors, and is non-representative of CLOCK high or DATA high. The added frame reduces the users perception of dramatic changes in hue and luminosity as the flashes go from low to high, and vice versa.

In some embodiments of EXAMPLE 2, the peak and minimum CLOCK and DATA frames would have a duration of about 166 milliseconds, whereas the inactive transitional frames between the peak and minimum frames would have a shorter duration than that, say 80 milliseconds.

EXAMPLE 3 shows two inactive transitional color frames with values intermediate between the peak and minimum CLOCK and DATA values. The two transitional frames would emit hues and intensities which are intermediate between the peak and minimum frame value hues and intensities.

In some embodiments of EXAMPLE 3, the peak and minimum CLOCK values and DATA values would have a duration of about 32 milliseconds each, whereas the inactive transitional frames would have a duration of about 8 milliseconds each. EXAMPLE #3 has the equivalent of several flashes per second, comprised of more than 60 frames per second. The user experience is very comfortable. There is little perceptible flickering or flashing, since the frame rate is well over the standard video rate of 24 frames per second. The overall luminance of the display does not vary sufficiently to exceed the test thresholds. The hue changes that transition from a minimum to a peak and vice versa are not discomforting. The hues change from green to blue to blue green and ruddy brown, avoiding starkly contrasting colors. However, the peak and minimum frame dwell duration time of 32 milliseconds is sufficient to trigger the sensors of the iot gadget.

In some embodiments the system would comprise an intelligent device with a display that emits visible light representative of Morse Code, and a gadget with a single visible light sensor to receive the visible light flashes and decode the light flashes back into Morse Code.

The Morse Code based system is very simple to implement and low cost. The software app to encode the Morse Code transmission into visible light flashes, and the gadget software to decode the visible light would be relatively simple. The gadget would have only one visible light sensor, which in additional embodiments could function in a reverse bias mode as a combination sender and receiver.

The Morse Code visible light flashing method is optimized to comply with the Harding F.P.A. test and the Wisconsin P.E.A.T. test, even when flashing at a rate faster than 4 flashes per second.

In one example, the Morse Code flashing could consist of a transition from a medium intensity green color to a medium intensity blue color and vice versa. Short duration green color flashes represent “dots”(“dits”), while longer duration green color flashes represent “dashes”(“dahs”), and the blue flashes in between the dots and dashes would represent the very short intracharacter gaps, or the short gaps between characters, or the longer gaps between words.

In one embodiment the r.g.b. Values for green would be R:0, G:120, B:48; whereas the values for blue would be R:0, G:48, B:144. In this embodiment the flashing would transition from a total intensity of 168 for the green flash to a total intensity of 192 for the blue flash, and vice versa, such that the viewer does not perceive a disturbing contrast in light intensity during the flashing. (The green value is lower in the green flash compared to the blue value of the blue flash, to compensate for the higher sensitivity of human vision to green colors.) Moreover, the color transitions from green to blue and back again would not be discomforting. Unhealthy red flashes, white flashes, and dim color (“black”) flashes are not used in this example.

All Morse Code transmissions consist of irregular flashes, since the dots have a duration of 1 time unit, the dashes have a duration of 3 time units, and the gap between words is 7 time units, which is irregular flashing. The irregular flashing pattern of Morse Code does not mesmerize or have a hypnotic effect on the viewer.

Many modern intelligent devices have processes which enable a fade or dissolve method. This fade or dissolve method allows continuous transitions from one frame color to another frame color. The fade or dissolve method makes the transition from one color to another continuous instead of separate transitional frames between CLOCK low and DATA low frames and CLOCK high and DATA high frames.

An embodiment comprising Morse Code with fade or dissolve transitions between the green flashes and blue flashes would be pleasing.

In some embodiments, inactive pauses of various durations, lasting from 0.5 seconds to 2 seconds, are randomly interspersed within the visual light communication, further reducing the perception of a mesmerizing or hypnotic stimulus to the user.

An intermittent internet connection for iot devices would be facile in a business office. It is typical for an office or cubicle to have many shelves surrounding a work station. The iot devices could be stationed on shelves facing the workstation computer display. In some embodiments a program would cause the computer to wake up every night, open an internet browser, and emit visual light communication to all the iot devices in the office, thus updating the iot device programs regularly.

In other embodiments, the intelligent device would emit the visual light transmission concurrently as a viewer activity during a television episode, or movie, or cartoon. The visual light transmission would occupy a portion of the broadcast screen, say the lower right hand corner, sometimes called picture in picture. At the appropriate time, the viewer would be guided by the broadcast program to hold the iot device near the area of the intelligent device screen that was broadcasting the clock flashes and data flashes. The intelligent device would broadcast by visual light communication a transmission to the iot device that would amplify the users enjoyment of both the broadcast program and the iot device.

For example, during the “I Love Lucy” Show, the broadcast channel could include a visual light communication transmission concurrent with the broadcast as picture in picture. In one episode of “I Love Lucy” , as Ricky surprises Lucy with her presents and birthday cards, the viewer is encouraged to capture Ricky's birthday card greeting with the iot device, which would be a replica of the same birthday card that Ricky had just given to Lucy.

Another example would occur during the Nielsen broadcast sweeps weeks. Viewers of the television program “The Golden Girls” would be prompted during “The Golden Girls” theme song to have their iot gadget ready every sweeps week episode to capture a new festive greeting exclusively for viewers. As the words of “The Golden Girls” theme song sing “ . . . the card attached would say, thank you for being a friend” the visual light communication would appear as a picture in picture on the viewers screen, say inset into the lower right hand corner of the display. The viewer would be prompted to hold their iot gadget close to the picture in picture. In this example the iot gadget would also be a greeting card, and the visual light communication would be a message which was complimentary to that broadcast episode of “The Golden Girls”, such as “The Golden Girls” Season 5 Episode 12 Have Yourself a Very Little Christmas, or “The Golden Girls” episode when Betty White discovers a birthday cake. In this example the viewer would discover what the birthday card really said!

Likewise a birthday card could be integrated into the tv program “Frasier” when he gets his surprise birthday party, and could also be added to the tv program “Cheers” for Norm's birthdays.

In the example of a broadcast cartoon program, the visual light communication would allow a child's action figure toy to mimic the actions and sounds of its counterpart cartoon character during the cartoon episode. During the episode the child would play with the action figure toy. As the episode unfolds, a picture in picture would appear inset on the display screen. The inset would broadcast the visual light communication to the action figure toy concurrently with the broadcast cartoon episode. In response to the visual light communication on the display screen, and ideally in coordination with the actions and sounds of the cartoon action figure, the action figure toy could ape the same motions and noises of its counterpart on the screen. Ideally the toy would have the sequence of actions and sounds already programmed into rom at the toy factory. The visual light communication would merely be a short startup program to trip the toys program into performing the activity already preprogrammed into the toys rom.

In “Toys communicating with LEDs: Enabling Toy Cars Interaction”, Tippenhauer et al. Of Disney Research teach about toys communicating with visual light communication.

The embodiments are not affected by the changing resolution and/or refresh rate and/or display technology (CRT, TFT, l.c.d. etc) of different computer or hand-held device monitors. These embod emts allows transmitting data over any kind of graphical computer displays.

### Advantages

From the description above, a number of advantages of some embodiments of my patent becomes evident:

(a) Data is converted into flashes of electromagnetic radiation, electromagnetic radiation which is safe for human exposure. All of the embodiments comply with the Harding F.P.A. Test and the University of Wisconsin P.E.A.T. Test.

(b) The electromagnetic radiation flashes are pleasant for the viewers. If infrared or ultrasonic, the radiation is not sensed by the viewer. If visible light, the visible light flashes are not high contrast, not changing rapidly in intensity, and not comprised of red flashes, white flashes, or dim intensity flashes. In one pleasant embodiment the colors flash from a ruddy brown to a green to a blue and to a pastel light blue-green, and back and forth continuously.

(c) The flashing and pulsing is not strobe-like, not hypnotic, not mesmerizing. The colors transition gently. In some embodiments inactive pauses of various durations are inserted randomly in the communication, to further reduce any possible hypnotic or mesmerizing effects from the flashes.

(d) In the case of visible light communication (V.L.C.) or Li-Fi, the system is very simple, requiring only a few additional low cost parts. And the overhead of the software is low cost to program and maintain as well.

(e) The system enables “the internet of things”. Now even low cost gadgets can have intermittent or continuous internet communication. The gadget firmware can be updated conveniently, possibly at night, when there is no human activity on the intelligent device. Or the gadget sensor data can be uploaded at night. In the case of an office, any computer display allows a website to push updates and downloads to and from the iot gadgets in an office cubicle.

(f) The system enables enjoyable viewer actives during broadcast programs. The viewer can download internet hyperlinks, or short messages, or initiate programs or graphics or music already stored in rom in a wearable iot gadget. The user does not have to use their cell phone to photograph a Q.R. Code, does not have to type a long website address into their tablet. Children can enjoy playing with their action figure toys, as their own action figure toy mimics the actions and noises of the action figure portrayed in the cartoon broadcast program.

The scope of the embodiments should be determined by the appended claims and their legal equivalents, rather than by the examples given.

I claim:

1. A system comprising:
a. a computer, or mobile computing device, or computer driven television display that has
1. a process for converting digital transmissions into the method of emitting flashes of electromagnetic radiation,
2. said method of emitting flashes of electromagnetic radiation has the characteristic of being safe for human exposure, and
b. a gadget
1. with a means to sense variations in the intensity and frequency and periodicity of flashes of electromagnetic radiation, and
2. a process to convert said variations in the intensity and frequency and periodicity of said flashes of electromagnetic radiation into alphanumeric code.

2. A synchronous system comprising:
a. computer, or mobile computing device, or a computer driven television display
1. with a process to convert digital transmissions into flashes of electromagnetic radiation whereby said flashes of electromagnetic radiation have the characteristic of being safe for human exposure, and
b. a gadget
1. with a means to sense variations in the intensity and frequency and periodicity of said flashes of electromagnetic radiation, and
2. a process to convert said variations in the intensity and frequency and periodicity of said flashes of electromagnetic radiation into alphanumeric code, and
3. a process to instruct one or a plurality of said gadget's emitters or combination sensor/emitters to emit flashes of electromagnetic radiation to the aforementioned computer or mobile computing device, and
c. said flashes of electromagnetic radiation emitted from said gadget are received by said aforementioned computer or mobile computing device,
1. said aforementioned computer or mobile computing device having a means to sense variations in the intensity and frequency and periodicity of said flashes of electromagnetic radiation emitted from said gadget, and
2. said aforementioned computer or mobile computing device having a process to convert said variations in the intensity and frequency and periodicity of said flashes of electromagnetic radiation into alphanumeric code.

3. The system of claim 1, comprising:
a. a computer, or mobile computing device, or computer driven television display that has
1. a process for converting digital transmissions into the method of emitting flashes of electromagnetic radiation,
2. said method of emitting flashes of electromagnetic radiation has the characteristic of being safe for human exposure, and
a. wherein the CLOCK portion of the digital transmission is converted into infrared flashes, and
b. the DATA portion of the digital transmission is converted into visible light flashes, and
b. a gadget that has
1. a means to sense said infrared flashes, and
2. a means to sense said visible light flashes, and
3. a process to convert variations in the intensity and frequency and periodicity of said infrared flashes and said visible light flashes into alphanumeric code.

4. The system of claim 1, comprising:
a. a computer, or mobile computing device, or computer driven television display that has
1. a process for converting digital transmissions into the method of emitting flashes of electromagnetic radiation,
2. said method of emitting flashes of electromagnetic radiation has the characteristic of being safe for human exposure, and
a. wherein the DATA portion of said digital transmission is converted into infrared flashes, and
b. the CLOCK portion of said digital transmission is converted into visible light flashes, and
b. a gadget that has
1. a means to sense said infrared flashes, and
2. a means to sense said visible light flashes, and
3. a process to convert variations in the intensity and frequency and periodicity of said infrared flashes and said visible light flashes of electromagnetic radiation into alphanumeric code.

5. The system of claim 1, wherein the gadget has a means to sense variations in the intensity and frequency and periodicity of the infrared flashes of electromagnetic radiation that is selected from the group comprising infrared sensors, infrared transducers, and infrared light emitting diodes.

6. The system of claim 1, wherein the gadget has a means to sense variations in the intensity and frequency and periodicity of the visible light flashes of electromagnetic radiation that is selected from the group comprising visible light photoelectric optical sensors, photo diodes, photo detectors, photo transistors, and optical sensors.

7. The system of claim 1, comprising
a. a computer, or mobile computing device, or computer driven television display that has
1. a process for converting digital transmissions into the method of emitting flashes of electromagnetic radiation,
2. said method of emitting flashes of electromagnetic radiation has the characteristic of being safe for human exposure, and
a. wherein the CLOCK portion of said digital transmission is converted into infrared flashes, and
b. the DATA portion of said digital transmission is converted into ultrasound flashes, and
b. a gadget that has
1. a means to sense said infrared flashes, and
2. a means to sense ultrasound flashes, and
3. a process to convert said variations in the intensity and frequency and periodicity of said infrared flashes and said ultrasound flashes of electromagnetic radiation into alphanumeric code.

8. The system of claim 1, comprising
a. a computer, or mobile computing device, or computer driven television display that has
1. a process for converting digital transmissions into the method of emitting flashes of electromagnetic radiation,
2. said method of emitting flashes of electromagnetic radiation has the characteristic of being safe for human exposure, and
a. wherein the CLOCK portion of said digital transmission is converted into ultrasound flashes, and
b. the DATA portion of said digital transmission is converted into infrared flashes, and
b. a gadget that has
1. a means to sense said ultrasound flashes, and
2. a means to sense said infrared flashes, and
3. a process to convert variations in the intensity and frequency and periodicity of said ultrasound flashes and said infrared flashes of electromagnetic radiation into alphanumeric code.

9. The system of claim 1, comprising
a. a computer, or mobile computing device, or computer driven television display that has
1. a process for converting digital transmissions into the method of emitting flashes of electromagnetic radiation,
2. said method of emitting flashes of electromagnetic radiation has the characteristic of being safe for human exposure, and
a. wherein the CLOCK portion of said digital transmission is converted into ultrasound flashes, and
b. the DATA portion of said digital transmission is converted into visible light flashes, and
b. a gadget
1. a means to sense said ultrasound flashes, and
2. a means to sense said visible light flashes, and
3. said gadget has a process to convert variations in the intensity and frequency and periodicity of said ultrasound flashes and said visible light flashes of electromagnetic radiation into alphanumeric code.

10. The system of claim 1, comprising
a. a computer, or mobile computing device, or computer driven television display, that has
1. a process for converting digital transmissions into the method of emitting flashes of electromagnetic radiation,
2. said method of emitting flashes of electromagnetic radiation has the characteristic of being safe for human exposure, and
3. a display that emits said flashes of electromagnetic radiation as a multitude of visible light wavebands,
a. wherein the CLOCK portion of said digital transmission is converted into a visible light waveband with a predetermined range, and
b. the DATA portion of said digital transmission is converted into a visible light waveband with a predetermined range, and
c. the waveband range of said DATA portion differs from the waveband range of said CLOCK portion, and
b. a gadget that has
1. a means to sense said waveband range representing said CLOCK portion of said digital transmission, and
2. a means to sense said waveband range representing said DATA portion of said digital transmission, and
3. a process to convert variations in the intensity and frequency and periodicity of said visible light wavebands of electromagnetic radiation into alphanumeric code.

11. The system of claim 1, wherein the computer, or mobile computing device, or computer driven television display has
a. a member with a means to emit visible light but does not emit flashes of white light, and
1. said member has a means to emit visible light but does not emit flashes of red light, and
2. said member has a means to emit visible light but does not emit flashes of white light followed by flashes of red light and vice versa, and
3. said member has a means to emit visible light but does not emit flashes of white light followed by flashes of light wherein the member emits red from few or no pixels, green from few or no pixels, and blue from few or no pixels,
4. said member has a means to emit visible light but does not emit flashes of red light followed by flashes of light wherein the member emits red from few or no pixels, green from few or no pixels, and blue from few or no pixels,
5. and said member has a means to emit visible light but does not emit any sequence of flashes of red light, interspersed with flashes of white light, or interspersed with flashes of light wherein the member emits red from few or no pixels, green from few or no green pixels, and blue from few or no blue pixels.

12. The system of claim 1, wherein the computer, or mobile computing device, or computer driven television display has a means to flash visible light at a rate faster than 50 flashes per second.

13. The system of claim 1, wherein the computer, or mobile computing device, or computer driven television display has a means to flash visible light at a rate of 1 to 3 flashes per second.

14. The system of claim 1, comprising
a. a computer, or mobile computing device, or computer driven television display that has a display comprised of a plurality of pixels that emit light at wide angles, and
b. a gadget that has one or a plurality of sensors that absorb light from wide angles, such that the cumulative effect of said pixels that emit light at wide angles added to the effect that said sensors that absorb light from wide angles,
c. said system is a wide angle system whereby line of sight transmission is not necessary.

15. The system of claim 1, comprising a computer, or mobile computing device, or computer driven television display that has
a. a process to convert digital transmissions into flashes of electromagnetic radiation,
b. said flashes of electromagnetic radiation are comprised of two different plurality of frames of visible light, and
c. said plurality of frames of visible light are comprised of a mixture of different wavebands which are representative of CLOCK low and CLOCK high and DATA low and DATA high, and
d. said flashes of electromagnetic radiation are also comprised of an additional plurality of frames of visible light that are non-representative of CLOCK high or DATA high,
e. said frames of visible light which are non-representative of CLOCK high or DATA high have the characteristic that they have intensities and frequencies which are intermediate between
1. said frames representative of CLOCK low and CLOCK high and DATA low and DATA high preceding said non-representative frames, and
2. said frames representative of CLOCK low and CLOCK high and DATA low and DATA high following said non-representative frames, and
f. said frames representative and said frames non-representative have the characteristic that the transitions from one frame to another is gradual and the frames do not have disturbing contrasts in intensity or frequency between them, and
g. said frames having the characteristic of being safe for human exposure.

16. The system of claim 1, wherein the computer or mobile computing device has a process for randomly inserting pauses comprised of non-representative frames of varying durations within the flashes of electromagnetic radiation.

17. The system of claim 1, wherein the flashes of electromagnetic radiation emitted by the computer or mobile computing device comply with the Harding F.P.A. test or the University of Wisconsin P.E.A.T. Test.

18. The system of claim 1, comprising
a. a computer, or mobile computer, or computer driven television display that emit flashes of electromagnetic radiation,
1. wherein said flashes of electromagnetic radiation are part of a broadcast program selected from the group comprising movies, television episodes, network episodes, broadcast events, plays, readings, athletic events, or cartoons; and
2. said flashes of electromagnetic radiation are emitted concurrently as part of said broadcast program,
3. said flashes of electromagnetic radiation have the characteristic of being safe for human exposure, and
b. a gadget with
1. a means to sense variations in the intensity and frequency and periodicity of said flashes of electromagnetic radiation, and
2. and a process to convert said variations in the intensity and frequency and periodicity of said flashes of electromagnetic radiation into alphanumeric code.

19. The system of claim 1, comprising
a. a computer, or mobile computing device, or computer driven television display, that has
1. a process for converting digital transmissions into the method of emitting visible light flashes representative of Morse Code,
2. said method of emitting visible light flashes having the characteristic of being safe for human exposure, and
b. a gadget
1. with a means to sense variations in the intensity and frequency and periodicity of visible light flashes, and
2. a process to convert said variations in the intensity and frequency and periodicity of said visible light flashes into alphanumeric code.

20. The system of claim 1, comprising
a. a computer, or mobile computing device, or computer driven television display that has
1. a process for converting digital transmissions into the method of emitting visible light flashes representative of Morse Code,
2. said method occurring at a rate faster than 3 flashes per second, and
2. said method of emitting visible light flashes having the characteristic of being safe for human exposure, and
b. a gadget
1. with a means to sense variations in the intensity and frequency and periodicity of visible light flashes, and
2. a process to convert said variations in the intensity and frequency and periodicity of said visible light flashes into alphanumeric code.

21. A method of communicating to a gadget, comprising:
a. providing a computer, or mobile computing device, or computer driven television display that has a process for converting digital transmissions into flashes of electromagnetic radiation whereby said electromagnetic radiation has the characteristic of being safe for human exposure, and
b. providing a gadget with a means for sensing variations in the intensity and frequency and periodicity of said flashes of electromagnetic radiation, and
c. providing said gadget with a process for converting said variations in the intensity and frequency and periodicity of said flashes of electromagnetic radiation into alphanumeric code, and
d. providing said gadget with a process for converting digital transmissions into flashes of electromagnetic radiation whereby said electromagnetic radiation have the characteristic of being safe for human exposure, and
e. providing the aforementioned computer, or mobile computing device, or computer driven television display with a means for sensing variations in the intensity and frequency and periodicity of said flashes of electromagnetic radiation emitted from said gadget, and
f. providing the aforementioned computer with a process for converting said flashes of electromagnetic radiation emitted from said gadget into alphanumeric code.
